(19) United States
(12) Patent Application Publication
(10) Pub. No.: US 2014/0057603 A1
(43) Pub. Date: Feb. 27, 2014

(54) METHOD AND SYSTEM FOR NETWORKING CONTROL OF APPLICATION PROGRAMS

(71) Applicant: Tencent Technology (Shenzhen) Company Limited, Shenzhen (CN)

(72) Inventor: Quan Hao XIAO, Shenzhen (CN)

(73) Assignee: Tencent Technology (Shenzhen) Company Limited, Shenzhen (CN)

(21) Appl. No.: 14/069,072

(22) Filed: Oct. 31, 2013

Related U.S. Application Data
(63) Continuation of application No. PCT/CN2013/082265, filed on Aug. 26, 2013.

(30) Foreign Application Priority Data
Aug. 24, 2012 (CN) 2012103052598

(51) Int. Cl. H04W 12/02

(52) U.S. Cl. CPC H04W 12/02
USPC 455/411

(57) ABSTRACT

The present disclosure provides method and system for networking control of application programs, and belongs to the field of computer technology. The method comprises: monitoring requests to access a mobile network sent from an application program to an application programming interface; intercepting and discarding a request to access the mobile network when detecting the request to access the mobile network, thereby preventing automatic access to the mobile network by the application program. The present disclosure accomplishes effective control of an application program's access to a mobile network, reduces communication flow of terminal users, and enhances privacy security of the terminal users.

### CROSS REFERENCE TO RELATED APPLICATION

This application is a U.S. continuation application under 35 U.S.C. §111(a) claiming priority, under 35 U.S.C. §120 and 365(c), to International Application No. PCT/CN2013/082265 filed on Aug. 26, 2013, which claims the priority benefit of Chinese Patent Application No. 201210305259.8, filed Aug. 24, 2012, the contents of both the PCT application and the Chinese application are incorporated by reference herein in their entirety for all purposes.

### TECHNICAL FIELD

The present disclosure relates generally to the technological field of computers, and more particularly, to a method and system for networking control of application programs.

### BACKGROUND

With the intelligentization of mobile terminals (such as smartphones and tablet PCs, etc.), many application programs for mobile terminals emerge one after another. Some software can establish network connection using a mobile terminal's wireless network without obtaining permission from or reminding a terminal user, and upload the terminal user's application program data or even private data to specific servers, thereby increasing the terminal user's communication flows and reducing the privacy security of the terminal user.

### SUMMARY OF THE DISCLOSURE

The present disclosure discloses a method and system for networking control of application programs to solve the following problem: existing technology cannot provide an effective application program networking control method, which causes an increase in a terminal user's communication flows and reduces privacy security of the terminal user.

According to the present disclosure, an application program networking control method comprises:

monitoring requests to access a mobile network sent from an application program to an application programming interface (“API”), and

intercepting and discarding a request to access the mobile network when detecting the request to access the mobile network, thereby preventing automatic access to the mobile network by the application program.

The present disclosure also discloses an application program networking control system, the system comprising:

a request monitoring unit that monitors request to access a mobile network sent from an application to an API, and

a request discarding unit that intercepts and discards a request to access the mobile network when detecting the request to access the mobile network, thereby preventing automatic access to the mobile network by the application program.

By monitoring requests to access a mobile network sent from an application program to an API, and intercepting and discarding a request to access the mobile network when detecting the request to access the mobile network, automatic access to the mobile network by the application program can be prevented, thereby accomplishing effective control of the application program's access to the mobile network, reducing communication flows of terminal users, and enhancing privacy security of the terminal users.

### BRIEF DESCRIPTION OF THE DRAWINGS

FIG. 1 is a schematic diagram illustrating an example of the flow of an application program networking control method according to various embodiments.

FIG. 2 is a schematic diagram illustrating an example of the flow of an application program networking control method according to various embodiments.

FIG. 3 is a schematic diagram illustrating an example of an arrangement of an application program networking control system according to various embodiments.

FIG. 4 is a schematic diagram illustrating an example of an arrangement of an application program networking control system according to various embodiments.

FIG. 5 is a schematic diagram illustrating an example of an arrangement of an application program networking control system according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

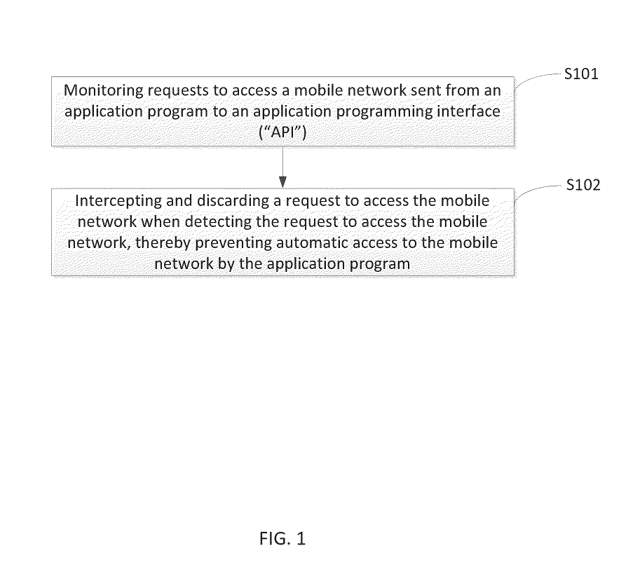

FIG. 1 is a schematic diagram illustrating an example of the flow of an application program networking control method according to various embodiments. The method can comprise:

Step S101: monitoring requests to access a mobile network sent from an application program to an application programming interface (“API”).

According to some embodiments, monitoring requests to access a mobile network sent from an application program to an API comprises monitoring the API, wherein the API is associated with access to the mobile network. According to some embodiments, monitoring requests to access a mobile network sent from an application program to an API comprises monitoring whether the application program has sent any request to access the mobile network to the API, wherein the API is associated with access to the mobile network. The mobile network can be a second generation mobile communication network, a third generation mobile communication network, or a fourth generation mobile communication network. Examples of a mobile network include, but are not limited to, a General Packet Radio Service (“GPRS”) network, a Wideband Code Division Multiple Access (“WCDMA”) network, a Code Division Multiple Access 2000 (“CDMA2000”) network, a Time Division-Synchronous Code Division Multiple Access (“TD-SCDMA”) network, and a Time Division Long Term Evolution (“TD-LTE”) network.

Step S102: intercepting and discarding a request to access the mobile network when detecting the request to access the mobile network, thereby preventing automatic access to the mobile network by the application program.

According to some embodiments, when detecting a request to access the mobile network sent from an application program to an API, the request to access the mobile network can be intercepted and discarded, thereby preventing automatic access to or an operation of uploading data to the mobile network. According to these embodiments, communication flows brought about by the application program's visiting the mobile network can be reduced. This can protect user privacy to some extent.

After discarding a request to access the mobile network, a networking failure message can be returned to the application program to prompt that the application program cannot access the requested mobile network. By way of example only, corresponding networking failure identification information can be returned to a thread or a process of the application program that sent the request to access the mobile network. After receiving the identification information, the application program can output corresponding networking failure prompt message to remind a terminal user.

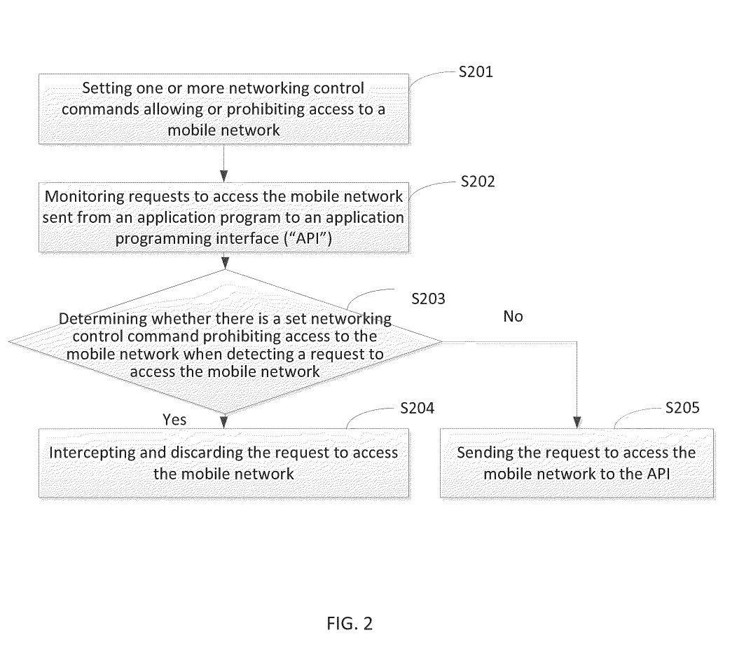

FIG. 2 is a schematic diagram illustrating an example of the flow of an application program networking control method according to various embodiments. The method can comprise:

Step S201: setting one or more networking control commands allowing or prohibiting access to a mobile network.

According to some embodiments, setting one or more networking control commands allowing or prohibiting access to a mobile network can allow a terminal user to conveniently and independently set whether to prohibit access to the mobile network with respect to each application program.

Step S202: monitoring requests to access the mobile network sent from an application program to an API.

According to some embodiments, monitoring requests to access the mobile network sent from an application program to an API can comprise monitoring via a set HOOK function.

Step S203: determining whether there is a set networking control command prohibiting access to the mobile network when detecting a request to access the mobile network. If yes, then proceed with Step S204. If no, then proceed with Step S205.

According to some embodiments, monitoring requests to access a mobile network sent from an application program to an API comprises monitoring the API, wherein the API is associated with access to the mobile network. According to some embodiments, monitoring requests to access a mobile network sent from an application program to an API comprises monitoring whether the application program has sent any request to access the mobile network to the API, wherein the API is associated with access to the mobile network. When detecting a request to access the mobile network, a determination can be made as to whether there is a networking control command prohibiting access to the mobile network set by a user.

Step S204: intercepting and discarding the request to access the mobile network, thereby preventing automatic access to the mobile network by the application program.

According to some embodiments, when detecting a request to access a mobile network sent from an application program to an API using a set HOOK function, a HOOK subprogram can be sent to the request to force the end of the transmission of the request, i.e., to discard the request, thereby preventing automatic access to the mobile network by the application program.

Step S205: sending the request to access the mobile network to the API.

According to some embodiments, when a terminal user allows an application program to access a mobile network, a request to access the mobile network sent from the application program can be sent to an API associated with access to the mobile network, enabling the application program to access the mobile network.

According to some embodiments, by setting one or more networking control commands allowing or prohibiting access to a mobile network, a terminal user can independently set whether to prohibit access to the mobile network with respect to each application program. This increases the controllability of application programs' mobile network access. When detecting a request to access a mobile network prohibited by a set networking control command, the request to access the mobile network can be intercepted and discarded, thereby preventing automatic access to the mobile network by an application program. This accomplishes effective control of application programs' mobile network access, reduces a terminal user's communication flows, and enhances the terminal user's privacy security.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

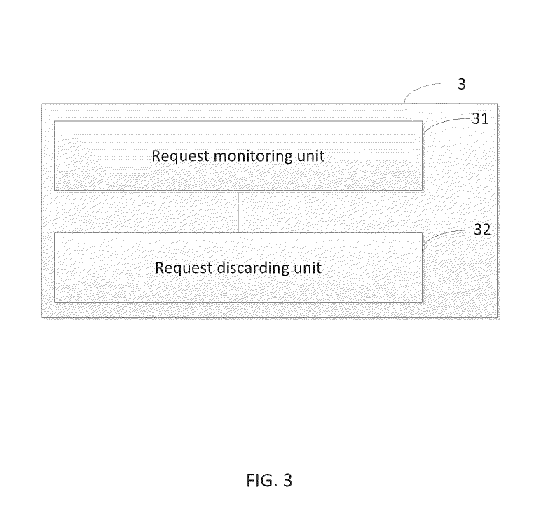

FIG. 3 is a schematic diagram illustrating an example of an arrangement of an application program networking control system according to various embodiments. As illustrated in FIG. 3, an application program networking control system 3 can comprise a request monitoring unit 31 and a request discarding unit 32, wherein

The request monitoring unit 31 monitors requests to access a mobile network sent from an application program to an API.

According to some embodiments, the request monitoring unit 31 monitors the API, wherein the API is associated with access to the mobile network. According to some embodiments, the request monitoring unit 31 monitors whether the application program has sent any request to access the mobile network to the API, wherein the API is associated with access to the mobile network.

The request discarding unit 32 intercepts and discards a request to access the mobile network when detecting the request to access the mobile network, thereby preventing automatic access to the mobile network by the application program.

According to some embodiments, when detecting a request to access the mobile network sent from an application program to an API, the request discarding unit 32 can intercept and discard the request to access the mobile network, thereby preventing automatic access to or an operation of uploading data to the mobile network. According to these embodiments, communication flows brought about by the application program's visiting the mobile network can be reduced. This can protect user privacy to some extent.

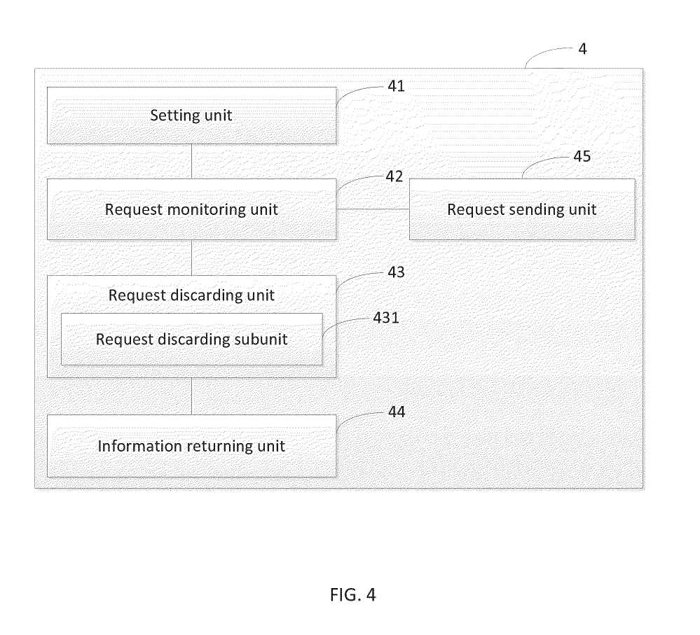

FIG. 4 is a schematic diagram illustrating an example of an arrangement of an application program networking control system according to various embodiments. As illustrated in FIG. 4, an application program networking control system 4 can comprise: a setting unit 41, a request monitoring unit 42, a request discarding unit 43, an information returning unit 44, and a request sending unit 45, wherein

The setting unit 41 sets one or more networking control commands allowing or prohibiting access to a mobile network.

According to some embodiments, setting one or more networking control commands allowing or prohibiting access to a mobile network can allow a terminal user to conveniently and independently set whether to prohibit access to the mobile network with respect to each application program.

The request monitoring unit 42 monitors requests to access the mobile network sent from an application program to an API.

The request discarding unit 43 intercepts and discards a request to access the mobile network when detecting the request to access the mobile network, thereby preventing automatic access to the mobile network by the application program.

According to some embodiments, when a networking control command allowing or prohibiting access to the mobile network is set by the setting unit 41, the request discarding unit 43 can comprise a request discarding subunit 431 that intercepts and discards a request to access the mobile network prohibited by a networking control command when detecting the request to access the mobile network.

The information returning unit 44 sends a networking failure message to the application program.

The request sending unit 45 sends a request to access the mobile network to the API when detecting the request to access the mobile network if access to the mobile network is allowed by a set networking control command.

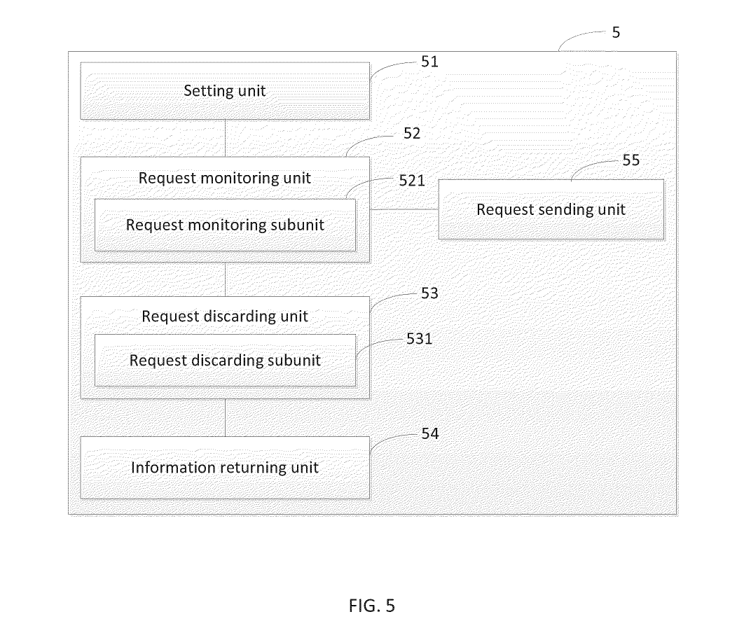

FIG. 5 is a schematic diagram illustrating an example of an arrangement of an application program networking control system according to various embodiments. As illustrated in FIG. 5, an application program networking control system 5 can comprise: a setting unit 51, a request monitoring unit 52, a request discarding unit 53, an information returning unit 54, and a request sending unit 55, wherein

The setting unit 51 sets one or more networking control commands allowing or prohibiting access to a mobile network.

According to some embodiments, setting one or more networking control commands allowing or prohibiting access to a mobile network can allow a terminal user to conveniently and independently set whether to prohibit access to the mobile network with respect to each application program.

The request monitoring unit 52 monitors requests to access the mobile network sent from an application program to an API.

According to some embodiments, monitoring requests to access the mobile network sent from an application program to an API can comprise monitoring via a set HOOK function. According to these embodiments, the request monitoring unit 52 can comprise a request monitoring subunit 521 that monitors requests to access the mobile network sent from the application program to the API via the set HOOK function.

The request discarding unit 53 intercepts and discards a request to access the mobile network when detecting the request to access the mobile network, thereby preventing automatic access to the mobile network by the application program.

According to some embodiments, when detecting a request to access a mobile network sent from an application program to an API using a set HOOK function, a HOOK subprogram can be sent to the request to force the end of the transmission of the request, i.e., to discard the request. According to these embodiments, the request discarding unit 53 can comprise a request discarding subunit 531 that intercepts and discards a request to access the mobile network via the set HOOK function when detecting the request to access the mobile network.

The information returning unit 54 sends a networking failure message to the application program.

The request sending unit 55 sends a request to access the mobile network to the API when detecting the request to access the mobile network if access to the mobile network is allowed by a set networking control command.

According to some embodiments, when detecting a request to access the mobile network sent from an application program to an API, the request discarding unit 32 can intercept and discard the request to access the mobile network, thereby preventing automatic access to or an operation of uploading data to the mobile network. According to these embodiments, communication flows brought about by the application program's visiting the mobile network can be reduced. This can protect user privacy to some extent.

The methods disclosed herein can be executed by a mobile terminal and the systems disclosed herein can be part of a mobile terminal. A mobile terminal can be a mobile phone, a tablet PC, a media player, etc. Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), a media player (including, but not limited to, Apple iPod and Microsoft Zoom), or an on-vehicle device running any of the above-mentioned operating systems or any other operating systems, or any other mobile Internet device (“MID”) or intelligent communication terminal, all of which are well known to those skilled in the art.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. An application program networking control method comprising:
monitoring requests to access a mobile network sent from an application program to an API, and
intercepting and discarding a request to access the mobile network when detecting the request to access the mobile network, thereby preventing automatic access to the mobile network by the application program.

2. The method of claim 1, comprising:
sending a networking failure message to the application program after intercepting and discarding the request to access the mobile network.

3. The method of claim 1, comprising:
setting one or more networking control commands allowing or prohibiting access to the mobile network before monitoring the requests to access the mobile network sent from the application program to the API.

4. The method of claim 3, wherein intercepting and discarding the request to access the mobile network when detecting the request to access the mobile network comprises:
intercepting and discarding the request to access the mobile network when detecting the request to access the mobile network if and only if there is a set networking control command prohibiting access to the mobile network.

5. The method of claim 1, wherein the mobile network comprises at least one of: a GPRS network, a WCDMA network, a CDMA2000 network, a TD-SCDMA network, and a TD-LTE network.

6. The method of claim 1, wherein monitoring the requests to access the mobile network sent from the application program to the API comprises monitoring the requests to access the mobile network sent from the application program to the API via a set HOOK function, and
intercepting and discarding the request to access the mobile network when detecting the request to access the mobile network comprises intercepting and discarding a request to access the mobile network via the set HOOK function when detecting the request to access the mobile network.

7. An application program networking control method comprising:
setting one or more networking control commands allowing or prohibiting access to a mobile network,
monitoring requests to access the mobile network sent from an application program to an API, and
sending a request to access the mobile network to the API when detecting the request to access the mobile network if there is no set networking control command prohibiting access to the mobile network or if and only if there is a set networking control command allowing access to the mobile network.

8. The method of claim 7, wherein the mobile network comprises at least one of: a GPRS network, a WCDMA network, a CDMA2000 network, a TD-SCDMA network, and a TD-LTE network.

9. An application program networking control system comprising:
a request monitoring unit that monitors request to access a mobile network sent from an application to an API, and
a request discarding unit that intercepts and discards a request to access the mobile network when detecting the request to access the mobile network, thereby preventing automatic access to the mobile network by the application program.

10. The system of claim 9, comprising:
an information returning unit that sends a networking failure message to the application program.

11. The system of claim 9, comprising:
a setting unit that sets one or more networking control commands allowing or prohibiting access to the mobile network.

12. The system of claim 11, wherein the request discarding unit comprises:
a request discarding subunit that intercepts and discards the request to access the mobile network when detecting the request to access the mobile network if and only if there is a set networking control command prohibiting access to the mobile network.

13. The system of claim 11, comprising:
a request sending unit that sends the request to access the mobile network to the API when detecting the request to access the mobile network if and only if there is a set networking control command allowing access to the mobile network.

14. The system of claim 11, comprising:
a request sending unit that sends the request to access the mobile network to the API when detecting the request to access the mobile network if there is no set networking control command prohibiting access to the mobile network.

15. The system of claim 9, wherein the mobile network comprises at least one of: a GPRS network, a WCDMA network, a CDMA2000 network, a TD-SCDMA network, and a TD-LTE network.

16. The system of claim 9, wherein
the request monitoring unit comprises a request monitoring subunit that monitors the requests to access the mobile network sent from the application program to the API via a set HOOK function, and
the request discarding unit comprises a request discarding subunit that intercepts and discards the request to access the mobile network via the set HOOK function when detecting the request to access the mobile network.
